(19) United States
(12) Patent Application Publication
(10) Pub. No.: US 2016/0129773 A1
(43) Pub. Date: May 12, 2016

(54) VEHICLE SHADING APPARATUS

(71) Applicant: Bin Liu, Dalian (CN)

(72) Inventor: Bin Liu, Dalian (CN)

(21) Appl. No.: 14/538,287

(22) Filed: Nov. 11, 2014

(51) Int. Cl. B60J 11/02

(52) U.S. Cl. CPC B60J 11/02

(57) ABSTRACT

A vehicle shading apparatus may include a first front shading control unit, a first rear shading control unit, a second top shading control unit, and a second rear shading control unit. In one embodiment, one end of the first top shading control unit is connected to the second top shading control unit. One end of the first rear shading control unit and a horizontal supporting unit are connected to the second rear shading control unit. The second top shading control unit and second rear shading control unit both include a shading cloth extending along the body of the vehicle. The present invention is advantageous because it has an automatic shading cloth expand/restore control unit and high-strength supporting unit. It is portable, easy to install and has the shading all around the vehicle to effectively block the sunlight.

### FIELD OF THE INVENTION

The present invention relates to a vehicle equipment, and more particularly to an energy-saving vehicle shading equipment.

### BACKGROUND OF THE INVENTION

Conventionally, the cover for vehicles for light, wind, or rain is usually a fixed structure on the ground. To reduce the sunlight to the vehicle, a tinted glass window or curtain is often used. However, conventional cover for vehicles is not portable, and tinted glass window or curtain does not effectively achieve the goal of blocking the sunlight. In addition, the vehicle body is made by metal which has a good heat transfer property, so even if the vehicle is under the sunlight for just an hour, the temperature inside the vehicle may increase to 45 to 60 degrees Celsius. Obviously, it will be difficult for the driver to drive under such a high temperature, so the driver may have to turn on the vehicle air conditioning first and wait for five to ten minutes before driving the vehicle, which causes loss of fuel and the wait time for the driver.

Meanwhile, the interior of the vehicle is made by engineering plastic materials, which may be decomposed or deteriorated under high temperature, and during the process of decomposition, toxic gases may be generated to adversely affect the driver's health.

Therefore, there remains a need for a new and improved vehicle shading apparatus to overcome the problems stated above.

### SUMMARY OF THE INVENTION

It is an object of the present invention to provide a vehicle shading apparatus to automatically expand and restore the shading cloth with high-strength supporting unit.

It is another object of the present invention to provide a portable vehicle shading apparatus, which is easy to install on top of the vehicle.

It is a further object of the present invention to provide a vehicle shading apparatus to effectively block the sunlight all around the vehicle.

In one aspect, a vehicle shading apparatus may include a first front shading control unit, a first rear shading control unit, a second top shading control unit, and a second rear shading control unit. In one embodiment, one end of the first top shading control unit is connected to the second top shading control unit. One end of the first rear shading control unit and a horizontal supporting unit are connected to the second rear shading control unit. The second top shading control unit and second rear shading control unit both include a shading cloth extending along the body of the vehicle.

In another embodiment, the horizontal supporting unit is used to guide the shading cloth on the second top shading control unit and the first top shading control unit toward the front of the vehicle; and the shading cloth on the second rear shading control unit and the first top shading control unit toward the rear of the vehicle. The first top shading control unit may include the shading cloth and a first vertical supporting unit, which is configured to manage the shading cloth to move downward. Likewise, the second top shading control unit may include the shading cloth and a second vertical supporting unit, which is configured to manage the shading cloth to move downward.

The vehicle shading apparatus further includes a right side shading control unit and left side shading control unit, wherein the right side shading control unit may include the shading cloth and a third vertical supporting unit, which is configured to manage the shading cloth to move downward; and the left side shading control unit may include the shading cloth and a fourth vertical supporting unit, which is configured to manage the shading cloth to move downward. It is noted that equipping the shading control units discussed above is according to the user's preference, especially the right side and left side shading control units are definitely optional. However, it is obvious that with the right side and left side shading control units, the vehicle shading effect would be enhanced.

In an exemplary embodiment, the first top shading control unit is used to control the shading cloth that expends vertically in front of the windshield; the first rear shading control unit is used to control the shading cloth that expends vertically to shade the rear windshield; the second top shading control unit is used to control the shading cloth that expends horizontally at the front of the car; the second rear shading control unit is used to control the shading cloth that expends horizontally at the rear of the car; and the right side and left side shading control units are used to control the shading cloth on both sides of the vehicle.

When the supporting unit moves forward, the first top shading control unit is driven along with the second top shading control unit to horizontally introduce the shading cloth until a predetermined position is reached, and the shading cloth of the first top shading control unit then expends downwardly and vertically. The identical mechanism applies to the first rear shading control unit and the second rear shading control unit. Finally, the right side and left side shading control units are also activated to vertically drop down the shading cloth.

In still a further embodiment, all of the first top shading control unit 1, the first rear shading control unit, the second top shading control unit, and the second rear shading control unit have a spool, a motor housing, and a spool driving unit, which is to drive the spool to restore the shading cloth. Each motor housing is used to support both sides of the spool and to support the rotation of the spool, and every spool is used for winding the shading cloth at the first top shading control unit, the first rear shading control unit, the second top shading control unit, and the second rear shading control unit, wherein the rail, spool and motor housing are made the composite material of steel and aluminum. The outer surface of the rail, spool and motor housing is an arc surface, and the edges and corners of the rail, spool and motor housing are round.

### BRIEF DESCRIPTION OF THE DRAWINGS

FIG. 1 illustrates a schematic view of the vehicle shading apparatus in the present invention.

FIG. 2 illustrates a schematic view of the vehicle shading apparatus that is partially expanded in the present invention.

FIG. 3 illustrates a schematic view of the vehicle shading apparatus that is mostly expanded in the present invention.

FIG. 4 illustrates a top view of the shading control units of vehicle shading apparatus.

FIG. 5 illustrates a schematic view of the shading control units of vehicle shading apparatus.

FIG. 6 is a schematic view of the right side shading control unit in the present invention.

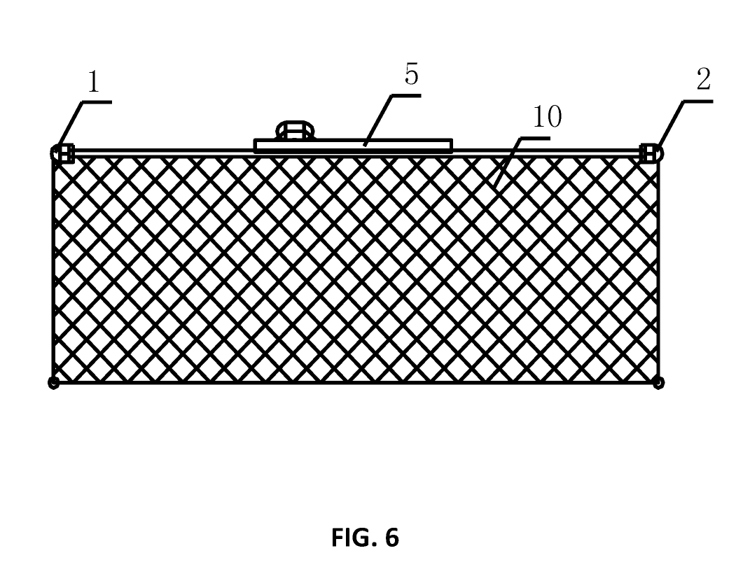

FIG. 7 is a top view of the shading cloth expanded to cover the vehicle in the present invention.

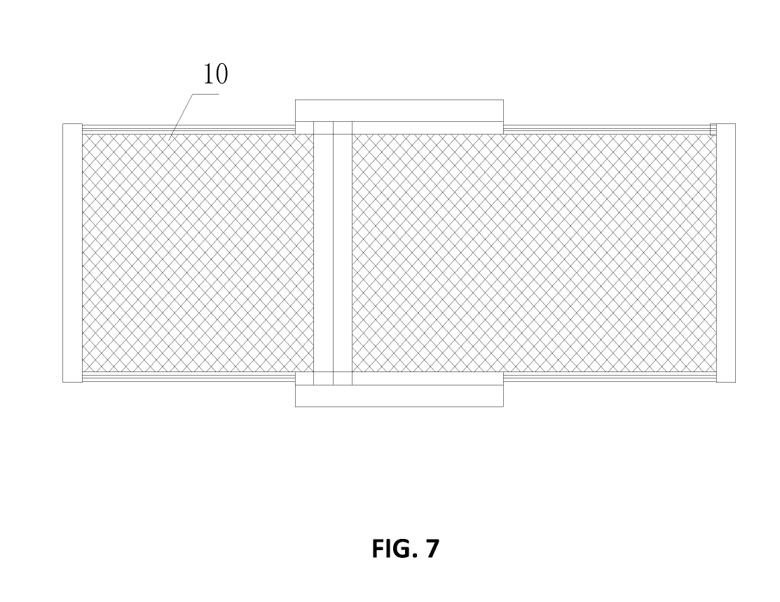

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

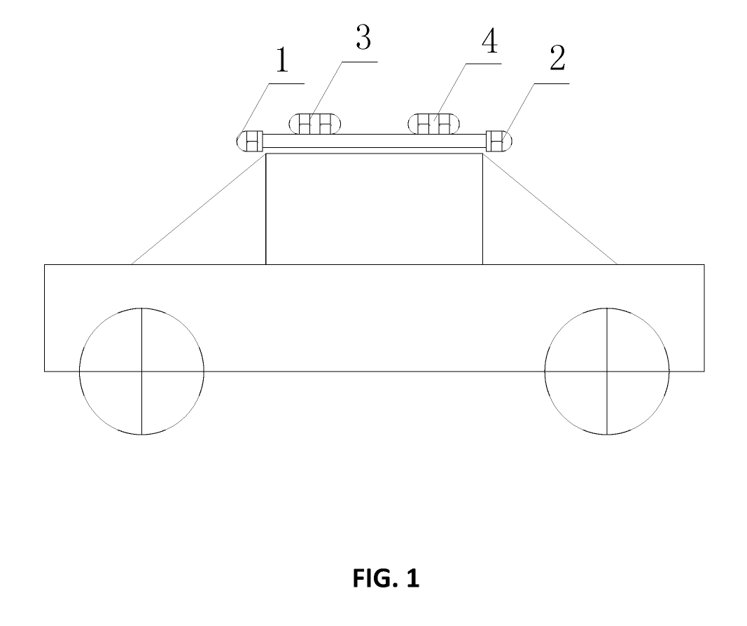

Referring to FIG. 1, a vehicle shading apparatus may include a first front shading control unit 1, a first rear shading control unit 2, a second top shading control unit 3, and a second rear shading control unit 4. In one embodiment, one end of the first top shading control unit 1 is connected to the second top shading control unit 3. One end of the first rear shading control unit 2 and a horizontal supporting unit 7 are connected to the second rear shading control unit 4. The second top shading control unit 3 and second rear shading control unit 4 both include a shading cloth 10 extending along the body of the vehicle.

The horizontal supporting unit 7 is used to guide the shading cloth 10 on the second top shading control unit 3 and the first top shading control unit 1 toward the front of the vehicle; and the shading cloth 10 on the second rear shading control unit 4 and the first top shading control unit 1 toward the rear of the vehicle. The first top shading control unit 1 may include the shading cloth 10 and a first vertical supporting unit 11, which is configured to manage the shading cloth 10 to move downward. Likewise, the second top shading control unit 2 may include the shading cloth 10 and a second vertical supporting unit 12, which is configured to manage the shading cloth 10 to move downward.

The vehicle shading apparatus further includes a right side shading control unit 5 and left side shading control unit 6, wherein the right side shading control unit 5 may include the shading cloth 10 and a third vertical supporting unit 13, which is configured to manage the shading cloth 10 to move downward; and the left side shading control unit 6 may include the shading cloth 10 and a fourth vertical supporting unit 14, which is configured to manage the shading cloth 10 to move downward. It is noted that equipping the shading control units discussed above is according to the user's preference, especially the right side and left side shading control units are definitely optional. However, it is obvious that with the right side and left side shading control units, the vehicle shading effect would be enhanced.

In an exemplary embodiment, the first top shading control unit 1 is used to control the shading cloth that expends vertically in front of the windshield; the first rear shading control unit 2 is used to control the shading cloth that expends vertically to shade the rear windshield; the second top shading control unit 3 is used to control the shading cloth that expends horizontally at the front of the car; the second rear shading control unit 4 is used to control the shading cloth that expends horizontally at the rear of the car; and the right side and left side shading control units (5, 6) are used to control the shading cloth on both sides of the vehicle.

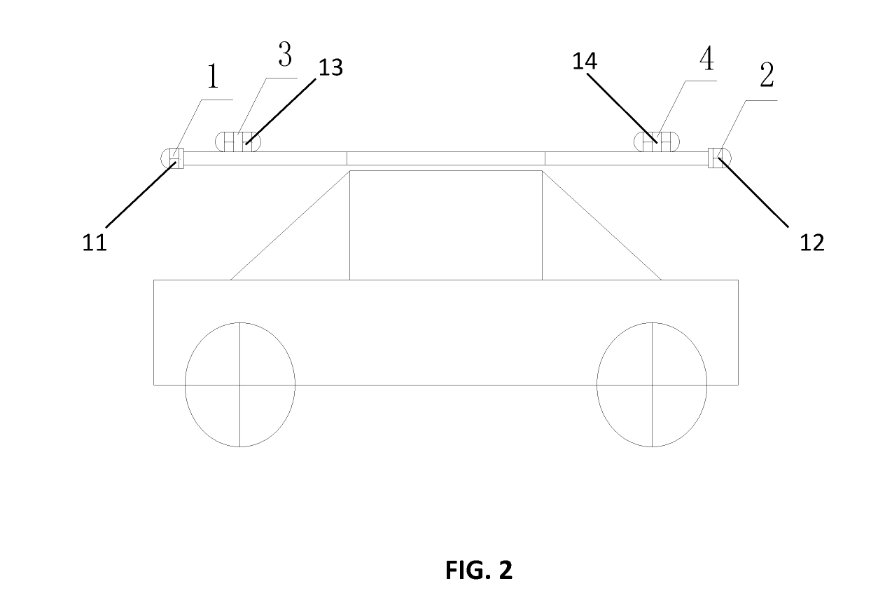

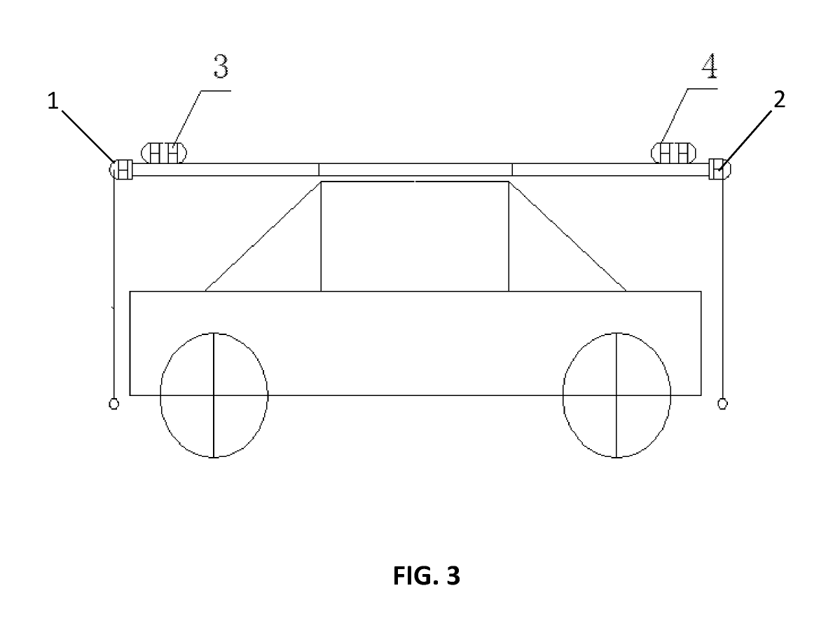

Referring to FIGS. 1 to 3, when the supporting unit moves forward, the first top shading control unit 1 is driven along with the second top shading control unit 3 to horizontally introduce the shading cloth until a predetermined position is reached (see FIG. 2), and the shading cloth of the first top shading control unit 1 then expends downwardly and vertically. The identical mechanism applies to the first rear shading control unit 2 and the second rear shading control unit 4. Finally, the right side and left side shading control units (5, 6) are also activated to vertically drop down the shading cloth.

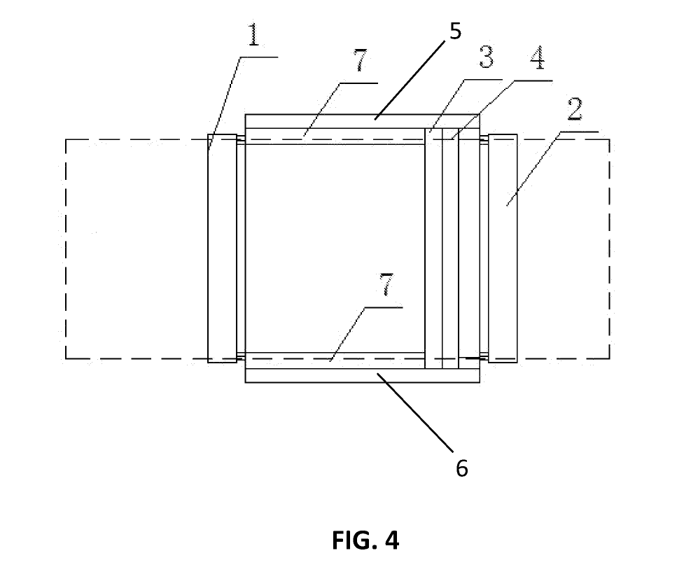

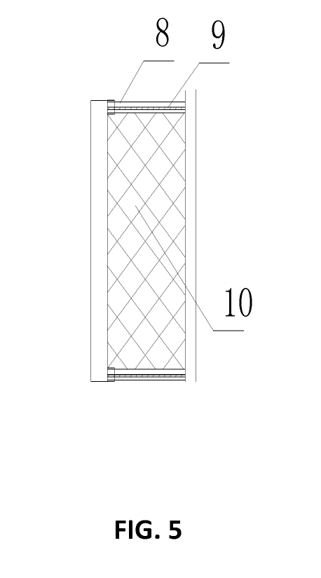

In a further embodiment as shown in FIG. 4, the horizontal supporting unit 7 may include two horizontal rails 8 (also see FIG. 5) and a dual-directional horizontal driving unit 9. In one embodiment, the dual-directional horizontal driving unit 9 may include a cylinder, a high-pressure air pump, a liquid pump or an electrical cylinder.

It is noted that the electrical cylinder uses a linear driving motor and a controller to produce a predetermined force for linear movement. Compared with conventional cylinder, the position, the speed and the force of the electrical cylinder can be precisely controlled. Also, it has the advantage of low noise, low vibration, high speed, energy saving, capable of adding any positioning point and long life. In machinery automation industry, electronic industry, automobile industry, the electric cylinder along with the controller can replace liquid and air cylinder. In the present invention, the electrical cylinder is equipped in the shading control units.

In still a further embodiment, all of the first top shading control unit 1, the first rear shading control unit 2, the second top shading control unit 3, and the second rear shading control unit 4 have a spool, a motor housing, and a spool driving unit, which is to drive the spool to restore the shading cloth. Each motor housing is used to support both sides of the spool and to support the rotation of the spool, and every spool is used for winding the shading cloth at the first top shading control unit 1, the first rear shading control unit 2, the second top shading control unit 3, and the second rear shading control unit 4, wherein the rail, spool and motor housing are made the composite material of steel and aluminum. The outer surface of the rail, spool and motor housing is an arc surface, and the edges and corners of the rail, spool and motor housing are round.

It is noted that to reduce the drag coefficient and adversary effect when the car is moving, the material of the shading apparatus is the composite material of steel and aluminum. The edges and corners of the rail, spool and motor housing are round to significantly reduce the size of the shading apparatus. Furthermore, the design of the arc surface can reduce the resistance when the car is moving.

It is also noted that the shading cloth and the spool driving unit are received together to save the space and reduce air resistance. The horizontal supporting units and vertical supporting units can be operated by high pressure air pump and high strength cylinder to ensure the safety. Moreover, the shading apparatus in the present invention can be attached/detached from the luggage rack on top of the car and the shading apparatus is not heavy due to the material of the components, so it is easy for the user to transport the shading apparatus.

In still a further embodiment, the shading cloth is made by colored satin, McBride or polyether ketone resin knitted fabrics. Analyzing the shading cloth can first determine the nature of the UV protection properties of the fabric. In general, cotton, silk, nylon and rayon has poor anti-UV performance, and polyester is better. Usually, color satin and McBride are used for shading cloth coated with polyester.

In an alternative embodiment, the rail has a plurality of connectors and each connector connects with the edges of the shading cloth. It is noted that the shading cloth expands along with the rails and there may be a gap between the shading cloth and the rail, which would adversely affect the shading efficiency. In the present invention, a plurality of connectors are disposed at the edges of the shading cloth to avoid the gaps, so the shading efficiency can be significantly enhanced.

According to the embodiments discussed above, the present invention is advantageous because it has an automatic shading cloth expand/restore control unit and high-strength supporting unit. It is portable, easy to install and has the shading all around the vehicle to effectively block the sunlight.

Having described the invention by the description and illustrations above, it should be understood that these are exemplary of the invention and are not to be considered as limiting. Accordingly, the invention is not to be considered as limited by the foregoing description, but includes any equivalents.

1. A vehicle shading apparatus comprising:
a first top shading control unit, a first rear shading control unit, a second top shading control unit, and a second rear shading control unit; one end of the first top shading control unit connected to the second top shading control unit; one end of the first rear shading control unit and a horizontal supporting unit connected to the second rear shading control unit; the first top shading control unit having a first shading cloth, and second top shading control unit including a second shading cloth extending along the body of the vehicle,
wherein the horizontal supporting unit is used to guide the first and second shading cloths on the first top shading control unit and the second top shading control unit respectively toward the front of the vehicle; and the third and fourth shading cloths on the first rear shading control unit and the second rear shading control unit toward the rear of the vehicle, and the first top shading control unit includes a first vertical supporting unit, which is configured to direct the first shading cloth to move downward, and the second top shading control unit includes a second vertical supporting unit, which is configured to direct the second shading cloth to move downward, and the first and second top shading control units moves horizontally with the first and second shading cloths.

2. The vehicle shading apparatus of claim 1, further includes a right side shading control unit and left side shading control unit, wherein the right side shading control unit includes a fifth shading cloth and a third vertical supporting unit, which is configured to manage the fifth shading cloth to move downward on the right side of the vehicle; and the left side shading control unit includes a sixth shading cloth and a fourth vertical supporting unit, which is configured to manage the sixth shading cloth to move downward on the left side of the vehicle.

3. The vehicle shading apparatus of claim 1, wherein the horizontal supporting unit includes two horizontal rails and a dual-directional horizontal driving unit, which includes a cylinder, a high-pressure air pump, a liquid pump or an electrical cylinder.

4. (canceled)

5. (canceled)

6. (canceled)

7. (canceled)

8. The vehicle shading apparatus of claim 1, wherein the shading cloth is made by colored satin, or polyether ketone resin knitted fabrics.

9. (canceled)

10. The vehicle shading apparatus of claim 1, wherein the shading apparatus is detachable from a top portion of a vehicle.
